(19) United States
(12) Patent Application Publication
(10) Pub. No.: US 2004/0073607 A1
(43) Pub. Date: Apr. 15, 2004

(54) Multimedia messaging system and method

(76) Inventors: Chi Chung Su, Tu-Chen (TW); Pengcheng Lee, Shenzhen (CN); Yuan Xu, Shenzhen (CN); XiangHua Ji, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/330,411

(22) Filed: Dec. 27, 2002

(30) Foreign Application Priority Data
Sep. 25, 2002 (TW) 91121952

(51) Int. Cl. G06F 15/16

(52) U.S. Cl. 709/203; 707/10

(57) ABSTRACT

A multimedia messaging system includes: a database (61) storing data on collection terms and client contact data, wherein the data on collection terms includes message sources, clients, collection terms, and monitoring cycles, and the contact data includes client names and addresses; a message collecting module (62) for acquiring messages that match collection terms set by users; a message processing module (66) for generating alert messages based on said data on collection terms and contact data, the alert messages comprising client addresses; and a message sending module (68) for sending generated alert messages to clients. A related method includes: (i) accessing message sources at a predefined monitoring cycle; (ii) querying the message sources according to predefined collection terms; (iii) acquiring a message that matches the collection terms; (iv) generating an alert message based on the acquired message and on client contact data; and (v) sending the alert message to clients.

### BACKGROUND OF THE INVENTION

1. Field of the Invention

The present invention relates to multimedia messaging systems and methods, and particularly to a system and method for collecting messages according to client demand, and for sending collected messages to corresponding clients.

2. Background of the Invention

Nowadays, many communication means are available for people to contact each other quickly and conveniently. Such means include short message service, E-mail, and so on. Communications technology has greatly changed the way of life of many people. In May, 2001, the GSM (Global System for Mobile communications) Association reported that over 500 billion short messages were sent by way of the GSM system in the first quarter of 2001. More and more message service providers are providing services such as financial information, stock information, news, and entertainment information. Many message service providers supply customized services. That is, clients can select message information according to individual needs. Message service providers classify the clients into different client groups based on what message information the clients want. When new message information is generated, a message service provider sends the message information to clients belonging to a client group that want the message information. A key to providing such customized services is how to manage data on clients and client groups efficiently and conveniently. U.S. Pat. No. 6,097,942, issued on Aug. 1, 2000, discloses a method and apparatus for defining and updating mobile service based on subscriber groups. The apparatus defines a plurality of client groups, with each client group corresponding to a group symbol. A plurality of application groups communicate with the client groups by way of the group symbols thereof.

Although the said disclosed invention can add new services and clients, it does not allow clients to select message information freely and flexibly. A system and method is needed for dynamically monitoring message sources for timely acquisition of message information that clients want, and for sending acquired message information to corresponding clients.

### SUMMARY OF THE INVENTION

Accordingly, an object of the present invention is to provide a multimedia messaging system for collecting messages according to client demand and for sending collected messages to corresponding clients.

Another object of the present invention is to provide a multimedia messaging method for collecting messages according to client demand and for sending collected messages to corresponding clients.

In order to accomplish the above-mentioned objects, the present invention provides a multimedia messaging system and method. The system comprises: a database storing data on collection terms and contact data on clients, wherein the data on collection terms comprises message sources, clients, collection terms, and monitoring cycles, and the contact data comprises client names and client addresses; a message collecting module for acquiring messages that match collection terms set by users; a message processing module for generating alert messages based on said data on collection terms and contact data, the alert messages comprising client addresses; and a message sending module for sending generated alert messages to clients.

A preferred embodiment of the method comprises the following steps: (i) accessing message sources at a predefined monitoring cycle; (ii) querying the message sources according to predefined collection terms based on client need; (iii) acquiring a message that matches the collection terms; (iv) generating an alert message based on the acquired message and on contact data of clients; and (v) sending the alert message to the clients.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of an application environment of a multimedia messaging system in accordance with a preferred embodiment of the present invention;

FIG. 2 is a schematic diagram of infrastructure of the multimedia messaging system of FIG. 1, said infrastructure including a data setting module;

FIG. 3 is an exemplary collection term tabulation in accordance with the preferred embodiment of the present invention;

FIG. 4 is a schematic diagram of infrastructure of the data setting module of FIG. 2; and

FIG. 5 is a flowchart of a multimedia messaging method in accordance with a preferred embodiment of the present invention.

### DETAILED DESCRIPTION OF PREFERRED EMBODIMENTS OF THE INVENTION

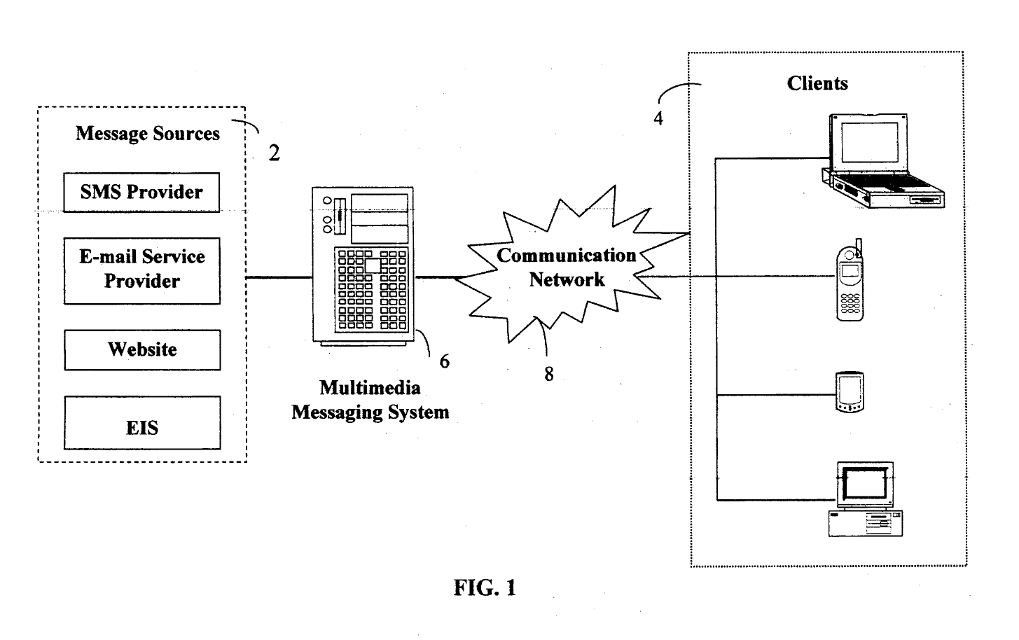

FIG. 1 is a schematic diagram of an application environment of a multimedia messaging system 6 in accordance with a preferred embodiment of the present invention. The multimedia messaging system 6 is linked to a plurality of message sources 2 for receiving various messages. The multimedia messaging system 6 processes received messages and generates corresponding alert messages. By means of a communication network 8, the multimedia messaging system 6 sends various generated alert messages to corresponding clients 4. The message sources 2 may be any one or more of a short message service (SMS) provider, an E-mail service provider, a website, and an enterprise information system (EIS). Once any message source 2 is registered in the multimedia messaging system 6, the message source 2 can provide various messages for the multimedia messaging system 6. The clients 4 may be any one or more of a personal computer, a mobile phone, a personal digital assistant, and a laptop computer. The communication network 8 may or may not be a wireless network.

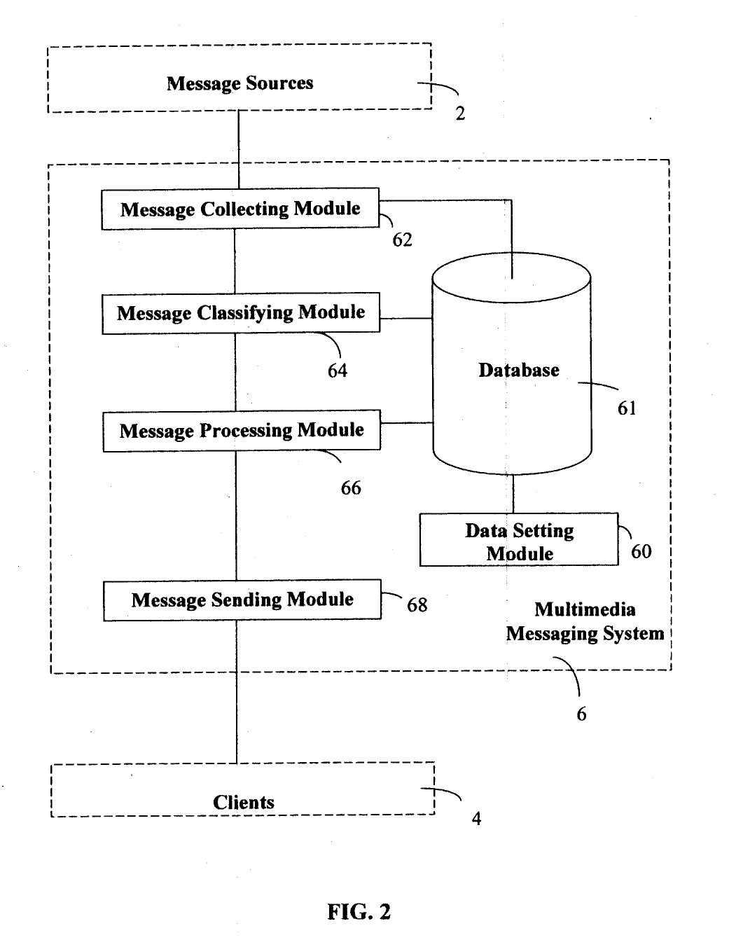

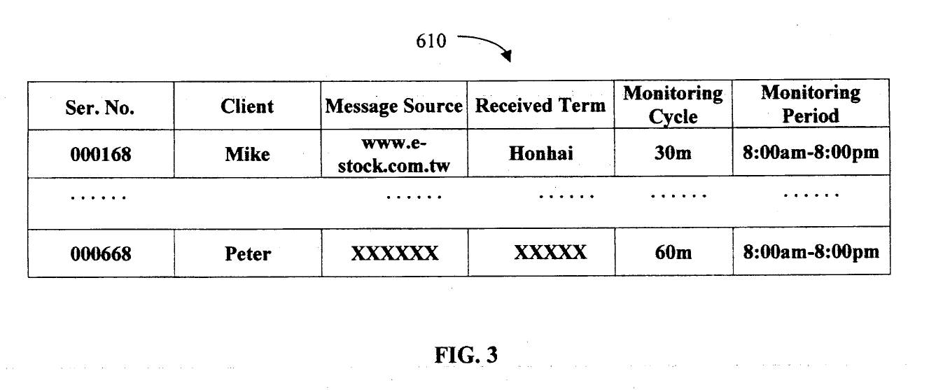

FIG. 2 is a schematic diagram of infrastructure of the multimedia messaging system 6. The multimedia messaging system 6 comprises a data setting module 60, a database 61, a message collecting module 62, a message classifying module 64, a message processing module 66, and a message sending module 68. The data setting module 60 is used for setting relevant basic data, such as data on collection terms and contact data on clients. Collection terms are key terms for collecting alert messages. A message can be received by the multimedia messaging system 6 only when terms of the message match a corresponding collection term. Each collection term comprises a serial number, a client name, a message source, a received term, a monitoring cycle, and a monitoring period. The monitoring cycle defines how often the multimedia messaging system 6 monitors the message sources 2 in a predefined monitoring period. The monitoring period is a time period during which the multimedia messaging system 6 monitors the message sources 2. FIG. 3 is an exemplary collection term tabulation 610. As illustrated in the collection term tabulation 610, from 8:00am to 8:00pm, every 30 minutes, the multimedia messaging system 6 monitors a message source, www.e-stock.com.tw, for any messages that include the term “Honhai,” and transmits any such message to a client named Mike.

The message collecting module 62 dynamically monitors the message sources 2, for acquiring messages that match collection terms set by users. The message classifying module 64 is used for determining whether the acquired messages are new messages. If an acquired message is a new message, the message collecting module 62 generates a monitoring record and stores it in the database 61. Each monitoring record comprises a serial number, a message source, a monitoring time, and message content. The message processing module 66 is used for generating an alert message based on a monitoring record in the database 61. The alert message comprises a transmission medium, a client transmission address, and message content. The message sending module 68 is used for sending alert messages to corresponding client addresses by means of corresponding transmission media.

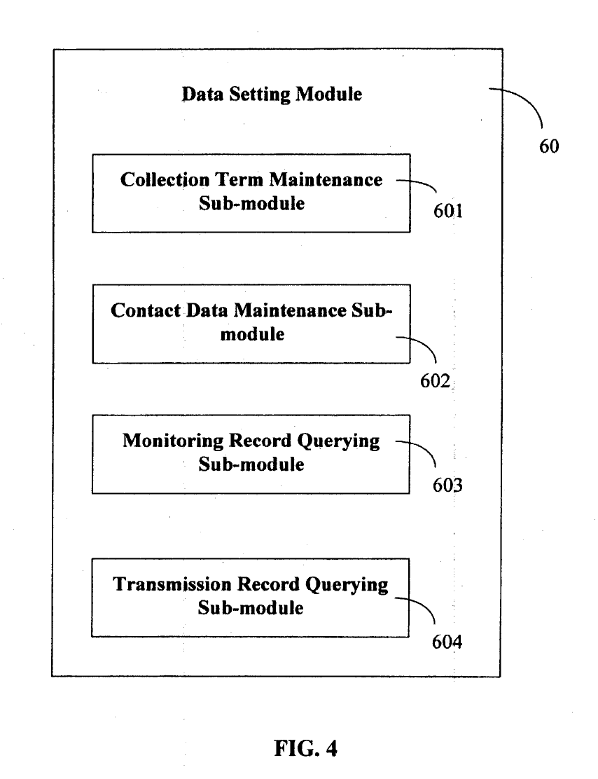

FIG. 4 is a schematic diagram of infrastructure of the data setting module 60 of the multimedia messaging system 6. The data setting module 60 comprises a collection term maintenance sub-module 601, a contact data maintenance sub-module 602, a monitoring record querying sub-module 603, and a transmission record querying sub-module 604. The collection term maintenance sub-module 601 is used for adding, modifying, deleting, or querying data on collection terms. The contact data maintenance sub-module 602 is used for adding, modifying, deleting, or querying contact data on clients. The monitoring record querying sub-module 603 is used for querying data on monitoring records. The transmission record querying sub-module 604 is used for querying data on transmission records. The transmission records comprise sending times, clients, sending addresses, and message contents.

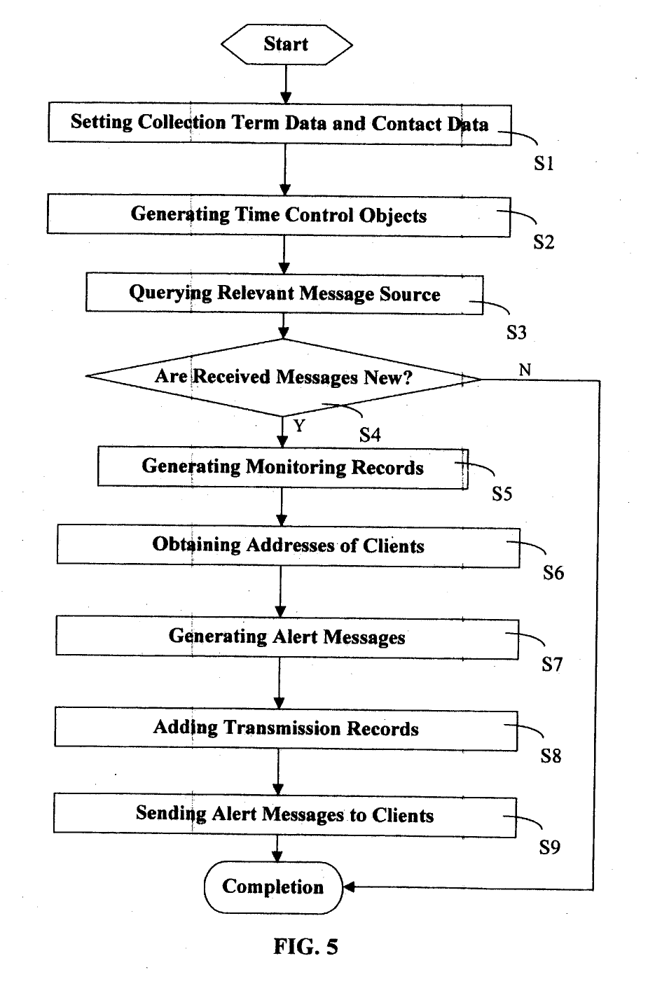

FIG. 5 is a flowchart of a multimedia messaging method in accordance with a preferred embodiment of the present invention. At step S1, by means of the data setting module 60, a user sets collection term data on alert messages and contact data on clients. At step S2, message collecting module 62 generates time control objects of the collection term data. The time control objects are used for controlling monitoring cycles of the message collecting module 62. At step S3, the message collecting module 62 queries a message source for any messages that include a predefined term. In the example illustrated in FIG. 3, the querying is performed during the monitoring period from 8:00am to 8:00pm, the message source is www.e-stock.com.tw, and the predefined term is “Honhai.” At step S4, the message classifying module 64 determines whether each acquired message is a new message. If an acquired message is not a new message, the procedure is completed. If an acquired message is a new message, at step S5, the message collecting module 62 generates a monitoring record on the acquired message. Monitoring records on all acquired messages form data on monitoring records. At step S6, the message processing module 66 queries the collection term tabulation 610 to obtain data on collection terms, and to obtain data on client addresses based on the data on collection terms. At step S7, the message processing module 66 generates alert messages based on the data on monitoring records and data on client addresses. At step S8, the message processing module 66 adds new transmission records to the database 61. At step S9, the message sending module 68 sends the generated alert messages to corresponding clients by way of corresponding transmission media, whereupon the procedure is completed.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A multimedia messaging system, comprising:
a database storing data on collection terms and contact data on clients, wherein the data on collection terms comprises message sources, clients, collection terms, and monitoring cycles, and the contact data comprises client names and client addresses;
a message collecting module for acquiring messages that match collection terms set by users;
a message processing module for generating alert messages based on said data on collection terms and contact data, the alert messages comprising client addresses; and
a message sending module for sending generated alert messages to clients.

2. The multimedia messaging system as claimed in claim 1, further comprising a data setting module for setting data on collection terms and contact data on clients.

3. The multimedia messaging system as claimed in claim 1, wherein the database stores data on monitoring records, the monitoring records comprising message sources, monitoring time, and message content.

4. The multimedia messaging system as claimed in claim 3, further comprising a message classifying module for determining whether the messages acquired by the message collecting module are new messages.

5. The multimedia messaging system as claimed in claim 1, wherein the data on collection terms comprises monitoring periods during which the message collecting module accesses message sources.

6. The multimedia messaging system as claimed in claim 4, wherein the database further stores data on transmission records, the transmission records comprising sending times, clients, sending addresses, and message contents.

7. A multimedia messaging method, the method comprising the steps of:
(a) accessing at least one message source at a predefined monitoring cycle;
(b) querying the at least one message source according to a predefined collection term based on client need;
(c) acquiring a message that matches the collection term;
(d) generating an alert message based on the acquired message and on contact data of at least one client;
(e) sending the alert message to the at least one client.

8. The multimedia messaging method as claimed in claim 7, wherein step (a) further comprises the step of:
setting collection term data and contact data on clients.

9. The multimedia messaging method as claimed in claim 7, wherein step (a) further comprises the step of:
generating time control objects for managing a monitoring cycle.

10. The multimedia messaging method as claimed in claim 7, wherein step (c) further comprises the step of:
(c1) determining whether the acquired message is a new message.

11. The multimedia messaging method as claimed in claim 10, wherein step (c1) further comprises the step of:
generating a monitoring record comprising message source, monitor time, and message content if the acquired message is a new message.

12. The multimedia messaging method as claimed in claim 11, further comprising the step of:
generating a transmission record comprising sending time, client/clients, sending address/addresses, and message content.

13. A method of efficiently transmitting proper information to specific clients individually, comprising steps of:
providing database storing data on collection factors including message sources, monitoring cycles, collection terms, and contact data on clients including client names and client addresses;
running a message collecting module to collect corresponding messages meeting said database storing data and said contact data for each of the clients;
processing and delivering said collected messages to the corresponding clients; and
modifying said data on the collection factors and said contact data on clients upon request by the clients.
